(19) United States
(12) Patent Application Publication
(10) Pub. No.: US 2023/0330561 A1
(43) Pub. Date: Oct. 19, 2023

(54) EXTRACTION OF ALKALOIDS USING AQUEOUS SOLUTION OF CARBONIC ACID

(71) Applicant: Jackson Processing, LLC, Sarasota, FL (US)

(72) Inventor: Joseph A. Bobier, Berea, WV (US)

(21) Appl. No.: 18/134,772

(22) Filed: Apr. 14, 2023

Related U.S. Application Data
(60) Provisional application No. 63/332,307, filed on Apr. 19, 2022.

(51) Int. Cl. B01D 11/02; C07B 63/02

(52) U.S. Cl. CPC B01D 11/0288; C07B 63/02; B01D 11/0284; B01D 11/0257

(57) ABSTRACT

An extraction method that uses only purified water and carbon dioxide whereby an aqueous solution of carbonic acid is used to extract alkaloids from biomatter is disclosed.

### CROSS-REFERENCE TO RELATED APPLICATION

The present application claims the benefit of previously filed co-pending Provisional Patent Application, Ser. No. 63/332,307 filed on Apr. 19, 2022.

### FIELD OF THE INVENTION

The process of this disclosure belongs to the field of alkaloid extractions. More specifically this disclosure addresses a process whereby an aqueous solution of carbonic acid is used to extract alkaloids from biomatter.

### BACKGROUND OF THE INVENTION

In the field of extractions a natural process is preferred over the use of organic solvents which require multiple chemical reactions, and can ether accidentally or intentionally leave solvent or chemical residues which are potentially dangerous or unwanted in the final extract product.

The process which is disclosed herein uses only purified water and carbon dioxide. The resulting extract product is therefore produced in a natural manner, which is preferred by consumers, creates no chemical waste, and presents no ecological hazards.

### BRIEF SUMMARY OF THE INVENTION

The method of this disclosure belongs to the field chemical extractions. More specifically this disclosure addresses a process whereby an aqueous solution of carbonic acid is used to extract alkaloids from biomatter.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a preferred embodiment diagram of the process of this disclosure.

### DESCRIPTION OF THE PREFERRED EMBODIMENT

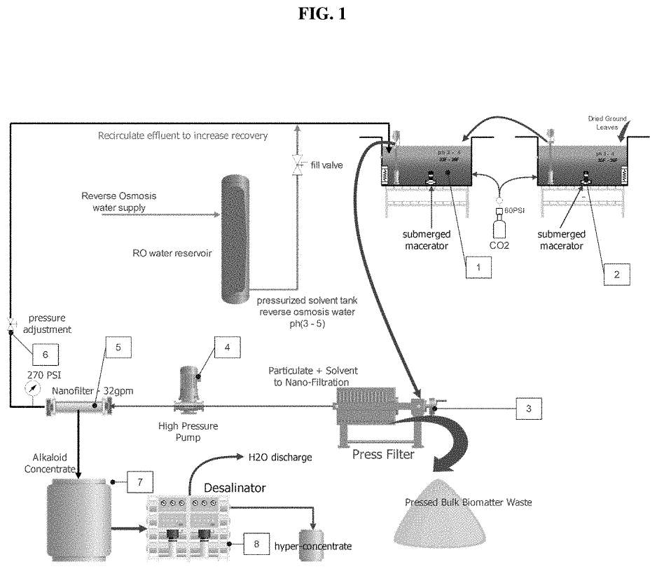

Referring to FIG. 1, the process begins with one or more extraction tanks, indicated by (1). Dried ground biomatter is added to the extraction tank (1). In this embodiment we indicate two extraction tanks as one arrangement. A single tank can be used, or multiple tanks can be added to increase volume and throughput of the overall system. We will describe the operation of this system as shown with two tanks, bearing in mind that a single tank could also be employed to similar effect.

Purified water is also added to the tank, such water preferably being sourced by reverse osmosis.

When the correct volume of dried, ground biomatter and purified water has been added to the tank, a macerating pump (2), which could be either a submerged or external air cooled design, will mix and agitate the biomatter and water to form a slurry.

The tank(s) will be cooled to a low temperature, just above the freezing point, approximately 34F (1C) by either a heat exchanger or a tank cooling jacket, typically using a glycol chiller and coolant pump. (external chiller not depicted)

Once the slurry is cooled, carbon dioxide is introduced into the mixture as depicted by CO² in the schematic.

Introducing CO² to the aqueous mixture at low temperature will cause the formation of carbonic acid (H²CO³) which will cause the PH of the aqueous mixture to lower to approximately a PH3.5. Reducing the PH of the mixture is important because many alkaloids are not very water soluble at the naturally neutral PH of approximately 7 for water. Adding CO² is a simple way to temporarily lower the PH of the water, forming or using no other potentially dangerous organic solvents or acids.

When the PH of the slurry has decreased to near 3.5, mixing continues for a prescribed period of time, depending on the nature of the biomatter and the alkaloids being extracted. If necessary, additional CO² is injected from time to time to maintain the low PH.

Once the extraction time has been reached, the slurry is pumped to a water/solid separator, depicted by (3). Typically, this is a press filter that squeezes the biomatter slurry, outputting the aqueous solution and ejecting the mostly dry biomatter as waste. However various other separation methods exist and are obvious to the inventor.

In this example, the aqueous fluid is piped to a high pressure pump (4) which drives the fluid through a nanometer pore size membrane (5). The typical membrane being of tubular design and the flow is tangential to the membrane pores. The membrane pores are of such size to allow water and the alkaloids to pass through, while larger molecules are rejected. Thus, the tangential flow that exits the membrane is called effluent, while the water and alkaloids that pass through the membrane pores is called concentrate.

The inventor is aware that other methods of separating the alkaloids from the aqueous solution exist and has considered various other methods which using chemical means can cause alkaloids to precipitate from the solution. However, in keeping with the natural means used to form the extract using only water and carbonic acid, the preferred embodiment uses the molecular filtration method described herein and no additional chemicals.

A pressure adjusting valve or regulator is shown in the effluent output pipe. This adjusts the pressure inside the membrane (6). A correct pressure and rate of tangential flow is necessary depending on the type of membrane used. We depict 270 PSI as typical.

Not all the alkaloids will be passed through the membrane pores, so to increase the efficiency of the system, the effluent is returned to the extracting tank(s), where it can pick up more alkaloids and circulate back to the filter press, high pressure pump and nanofilter membrane. Recirculation continues until all the aqueous fluid, consisting of only water and alkaloids has passed through the membrane pores.

The concentrate fluid which the membrane has produced is stored in a tank (7) which is a storage buffer that supplies a desalinator (8) with the concentrate solution. The desalinator is commonly used aboard boats and ships for remove salt and other impurities from sea water, its output consisting of pure water which is used by the crew for drinking water production. It's effluent consisting of concentrated brine is discharged overboard back to the sea. In this embodiment, the desalinator is used to remove water from the aqueous solution/alkaloid concentrate, further concentrating the alkaloid content. We call the concentrated solution hyper-concentrate which is at or near saturated state of alkaloids. This hyper-concentrate can be used as final product as-is, or further de-watered through any number of methods such as spray drying, wiped-film drying, evaporation or other common methods to produce a dry powder of alkaloids.

The preferred embodiment uses the desalination process to concentrate the alkaloids because there is no chemical process involved to precipitate the alkaloids out of the aqueous solution. However chemical means of alkaloid precipitation and filtering are obvious and known, but such use could eliminate the distinction of the product being extracted using organic and natural means.

Various configurations of the extant system are obvious which can increase efficiency and scale the system down or up according to the needs of the operator and do not change the spirit or concept of the invention.

What is claimed is:

1. A method whereby an aqueous solution of carbonic acid is used to extract alkaloids from biomatter comprising:
first adding dried ground biomatter to an extraction tank;
then adding purified water to said extraction tank;
then mixing and agitating said combined dried ground biomatter and said purified water to form a slurry;
then cooling said extraction tank to a temperature just above the freezing point;
then introducing carbon dioxide into said slurry causing the formation of carbonic acid (H²CO³) which will cause the PH of the aqueous mixture to lower to approximately a PH3.5;
then continuing mixing for a prescribed period of extraction time depending on the nature of the biomatter and the alkaloids being extracted and injecting additional CO² from time to time to maintain the low PH; and,
then once the prescribed period of extraction time has been reached pumping the slurry to a water/solid separator.
